(19) United States
(12) Patent Application Publication
(10) Pub. No.: US 2008/0126196 A1
(43) Pub. Date: May 29, 2008

(54) System and method for a consumer notification and a retail item purchase price negotiation

(75) Inventors: Jorge L. Perdomo, Boca Raton, FL (US); Juan C. Fernandez, Boca Raton, FL (US)

Correspondence Address: MOTOROLA;c/o DARBY & DARBY PC, P.O. BOX 770, CHURCH STREET STATION, NEW YORK, NY, 10008-0770, US

(73) Assignee: MOTOROLA, INC., Schaumburg, IL (US)

(21) Appl. No.: 11/673,715

(22) Filed: Feb. 12, 2007

Related U.S. Application Data
(60) Provisional application No. 60/867,718, filed on Nov. 29, 2006.

(51) Int. Cl. G06Q 30/00

(52) U.S. Cl. 705/14

(57) ABSTRACT

A method is provided for interacting with a consumer in a shopping establishment. The method includes communicating a notification to a wireless communications device located in a shopping establishment and belonging to a consumer. The notification identifies a retail item having a negotiable purchase price or a special purchase price based on a consumer profile, a consumer shopping list, a prior consumer purchase, or a consumer buying trend. The notification also identifies a retail item having a special purchase price based on a total quantity existing in an inventory, a special purchase price only available during certain times of a day, or a special online purchase price. The method also includes determining whether a consumer wants to negotiate a purchase price for a retail item. The method further includes negotiating a purchase price for the retail item if the consumer wants to negotiate a purchase price for the retail item.

### CROSS REFERENCE TO RELATED APPLICATIONS

This application claims the benefit of priority to U.S. provisional patent application Ser. No. 60/867,718 filed on Nov. 29, 2006, which is incorporated by reference as if fully rewritten herein.

### STATEMENT OF THE TECHNICAL FIELD

The inventive arrangements relate generally to an improved marketing and shopping system. More particularly, the present invention relates to systems and methods wherein a consumer receives notifications identifying retail items having special purchase prices and/or negotiable purchase prices. The present invention also relates to systems and methods wherein a consumer negotiates a purchase price for a retail item directly with a retailer.

### DESCRIPTION OF THE RELATED ART

Conventional marketing and shopping systems typically provide a means for negotiating a purchase price for retail items. For example. U.S. Pat. No. 6,249,772 discloses a system and method which enables a manufacture to control a customer price of goods and services, while preserving the profitability of a retailer. This is accomplished by enabling a manufacture to establish a ‘private’ price between himself and a customer. U.S. Pat. No. 5,794,207 discloses a method and apparatus for a cryptographically assisted commercial network system designed to facilitate buyer-driven conditional purchase offers. The disclosed method and apparatus allows prospective buyers of goods and services to communicate a biding purchase offer globally to potential sellers. The disclosed method and apparatus also allows sellers to search for relevant buyer purchase offers and to bind a buyer to a contract based on a buyer purchase offer.

Such conventional marketing and shopping systems also provide a means for delivering electronic coupons to a consumer. For example, U.S. Publication No. 2005/0234771 discloses an electronic coupon system for delivery of coupons within a shopping establishment. Similarly, U.S. Pat. No. 6,317,718 discloses a system for providing electronic coupon information to a consumer present in a shopping establishment. However, the electronic coupon information is based on a shopping list of a consumer present in a shopping establishment.

Despite the advantageous of such conventional marketing and shopping systems, there currently exists a need for an electronic notification system that encourages consumers to shop in a shopping establishment during off-peak hours or through an online shopping system. There is also a need for an electronic notification system that persuades a consumer to shop frequently at the shopping establishment and/or informs a consumer that he/she is overdue for purchasing a particular retail item. There is further a need for an electronic notification system that provides a purchase price reduction based on available retail items at a shopping establishment.

### SUMMARY OF THE INVENTION

The invention concerns a method for interacting with a consumer in a shopping establishment. The method includes communicating a notification to a wireless communications device belonging to a consumer. The wireless communications device is located within an area of a shopping establishment. Such areas include, but are not limited to, an entrance of a shopping establishment an aisle of the shopping establishment, and/or an end cap of a shopping establishment aisle. The notification identifies a retail item having a special purchase price and/or a retail item having a negotiable purchase price. The method also includes determining whether the consumer is interested in negotiating a purchase price for a retail item having a negotiable purchase price. If the consumer is interested in negotiating a purchase price for the retail item having a negotiable purchase price, then the method further includes communicating with the wireless communications device to negotiate a purchase price for the same.

According to an aspect of the invention, the notification is communicated to the wireless communications device via a wireless network. The wireless network is a local area network, a wide area network, or a personal area network. Such personal area networks include, but are not limited to, a Bluetooth based personal area network, an 802.11 based personal area network, and/or an 802.15.4 based personal area network.

According to another aspect of the invention, the method includes selecting the special purchase price to be a special purchase price based on a total quantity of a retail item existing in an inventory. According to another aspect of the invention, the method includes selecting the special purchase price to be a special purchase price based on a consumer profile or a consumer shopping list. The consumer profile is stored in a memory of the wireless communications device. The consumer shopping list is also stored in a memory of the wireless communications device.

According to another aspect of the invention, the method includes selecting the special purchase price to be a special purchase price based on a prior purchase of a retail item by the consumer. The method also includes selecting the special purchase price to be a special purchase price based on a consumer buying trend.

According to yet another aspect of the invention, the method includes selecting the special purchase price to be a special purchase price only available during selected times of a business day. For example, the special purchase price is only available during off-peak hours of the business day. The method also includes selecting the special purchase price to be an online store purchase price. The method further includes selecting the special purchase price to be a special purchase price available only to consumers in a shopping establishment when the notification is sent.

### BRIEF DESCRIPTION OF THE DRAWINGS

Embodiments will be described with reference to the following drawing figures, in which like numerals represent like items throughout the figures, and in which:

FIG. 1 is a block diagram of a shopping establishment that is useful for understanding the present invention.

FIG. 2 is a simplified block diagram for a consumer/retailer system that is useful for understanding the present invention.

FIG. 3 is a simplified block diagram for a consumer communications device shown in FIG. 2 that is useful for understanding the present invention.

FIG. 4 is a simplified block diagram for a retailer computer system shown in FIG. 2 that is useful for understanding the present invention.

FIGS. 5A-5F collectively illustrate a method for consumer notification and retail item purchase price negotiation that is useful for understanding the present invention.

### DETAILED DESCRIPTION OF THE PREFERRED EMBODIMENTS

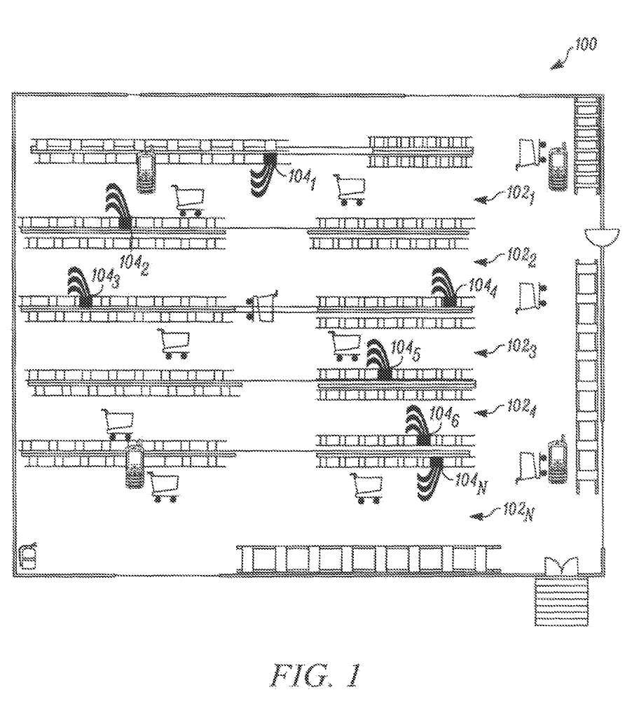

Embodiments of the present invention will now be described with respect to FIGS. 1-5F. Some embodiments of the present invention provide methods, systems, and apparatus relating to an improved marketing and shopping system. More particularly, the present invention relates to systems and methods wherein a consumer receives notifications identifying retail items having special purchase prices and/or negotiable purchase prices. The present invention also relates to systems and methods wherein a consumer negotiates a purchase price for a retail item directly with a retailer.

Referring now to FIG. 1, there is provided a block diagram of a shopping establishment 100. As shown in FIG. 1, consumers having wireless communications devices enter the shopping establishment 100. In this regard, it should be appreciated that the term “consumer” as used herein refers to an individual who buys goods from a seller or retailer. Once within the shopping establishment 100, notifications are communicated to the wireless communications devices. As should be appreciated, the term “notification” as used herein refers to an electronic communication containing information that is useful to a consumer who is interested in purchasing one or more items. For example, the notification can contain information concerning the purchase price of a retail item. The notification can also include information regarding whether a purchase price is negotiable. The term “retail item” as used herein refers to a good or service sold by a business seller or retailer to a consumer.

According to an embodiment of the invention, the notifications are communicated to the wireless communications devices via a wireless network. The wireless network includes, but is not limited to, a wireless local area network (LAN), a wireless wide area network (WAN), and/or a wireless personal area network (PAN). The wireless PAN is a Bluetooth based PAN, an 802.11 based PAN, an 802,15.4 based PAN, or any other wireless PAN.

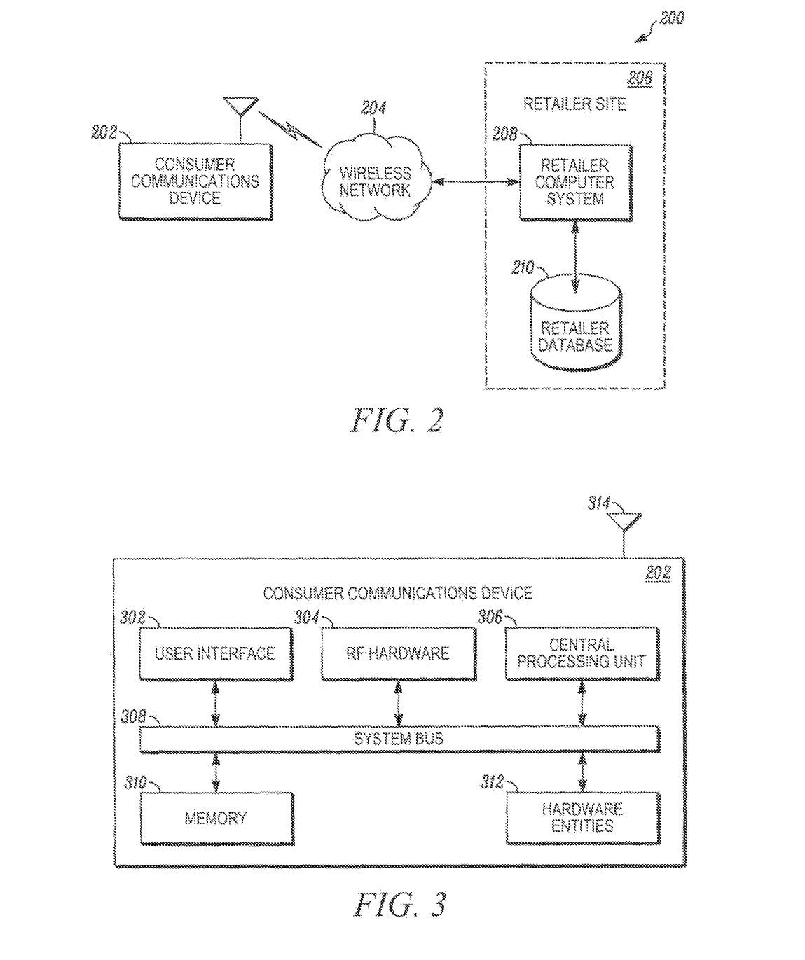

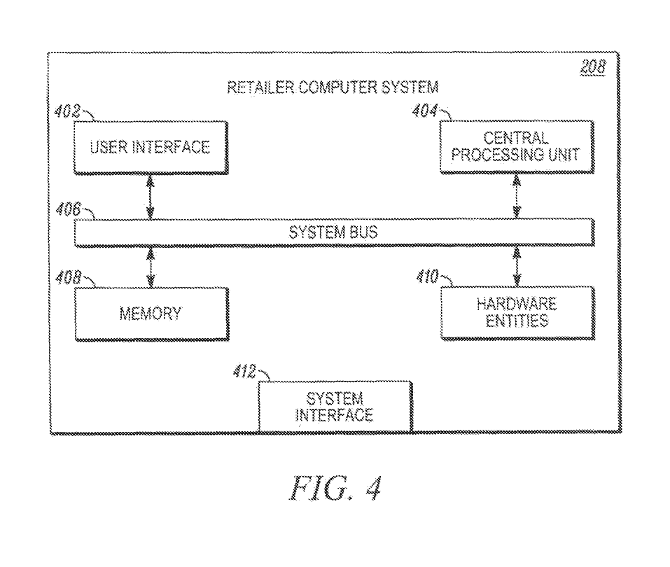

As will he understood by a person skilled in the art, the wireless network is comprised of wireless transceivers 104₁-104_{N} configured for enabling communications between two electronic devices. The electronic devices are wireless WAN enabled devices, wireless LAN enabled devices, and/or wireless PAN enabled devices. For example, the electronic devices include a consumer communications device (described below in relation to FIG. 2 and FIG. 3) and a retailer computer system (described below in relation to FIG. 2 and FIG. 4).

As shown in FIG. 1, the wireless transceivers 104₁-104_{N} are located within particular areas of interest. For example, the wireless transceivers 104₁-104_{N} are located within aisles of the shopping establishment and/or on end caps of the shopping establishment aisles. In this regard, it should be appreciated that the wireless transceivers 104₁-104_{N} are arranged in a configuration so as to avoid signal overlap and/or signal corruption.

It should also be appreciated that the notifications identify retail items having special purchase prices. The phrase “special purchase price” as used herein refers to a selling price for a retail item that is less than a selling price for the retail item at certain other times. Accordingly, the notifications can identify retail items having special purchase prices only available during certain times of a business day, a special online store purchase price, and/or a special purchase price based on a total quantity existing in an inventory. The notification can also identify retail items having a special purchase price based on a consumer buying trend, a consumer profile, or a consumer shopping list.

It should further be appreciated that the notifications identify retail items having a negotiable purchase price. The phrase “negotiable purchase price” as used herein refers to a purchase price for a retail item that a consumer can negotiate directly with a seller or retailer. In this regard, it should be understood that a consumer can negotiate with a retailer a purchase price for a retail item identified as having a negotiable purchase price. The consumer can also negotiate with a retailer a purchase price of a non-advertised retail stem only available at a particular point of sale. Such negotiations are achieved through the use of a consumer/retailer system described below in relation to FIG. 2.

Referring now to FIG. 2, there is provided a block diagram of a consumer/retailer system 200 that is useful for understanding the present invention. The consumer/retailer system 200 is comprised of a consumer communications device 202, a communications network 204, and a retailer site 206. The retailer site 206 is comprised of a retailer computer system 208 and a retailer database 210. Although a single retailer database 210 is shown in FIG. 2, it should be understood that the retailer site 206 can be comprised of any number of retailer databases in accordance with a particular retailer site 206 application.

Referring again to FIG. 2, it should be understood that the consumer communication device 202 is a mobile telephone, a personal digital assistant, or other handheld communications device. The consumer communication device 202 is wireless WAN enabled, wireless LAN enabled, and/or wireless PAN enabled. As shown in FIG. 2, the consumer communications device 202 is connected to the retailer computer system 208 through a wireless network 204.

The wireless network 204 is a wireless local area network (LAN), a wireless wide area network (WAN), or a wireless personal area network (PAN). The wireless PAN is a Bluetooth based PAN, an 802.11 based PAN, an 802.15.4 based PAN, or any other wireless PAN. Still, the invention is not limited in this regard. The wireless network 204 can be of any type suitable for a particular consumer/retailer system 200 application.

The retailer computer system 208 is a desktop personal computer system, a laptop personal computer system, or any other general purpose computer processing device. The retailer computer system 208 is wireless WAN enabled, wireless LAN enabled, and/or wireless PAN enabled. As shown in FIG. 2, the retailer computer system 208 is coupled to the retailer database 210. In this regard, it should be understood that the retailer computer system 208 accesses the retailer database 210 through any means known in the art. For example, the retailer computer system 208 the retailer database 210 through a direct connection, a local area network (LAN), a wide area network (WAN), or an internet using an Internet Service Provider.

The retailer database 210 is the retailer site's 206 storage medium comprising data associated with retail item information. For example, such data associated with a retail item can include a retail item identifier, a retail item description, a quantity of retail items existing in an inventory, and/or a preferred purchase price for a retail item. The retailer database 210 can also include consumer account information. For example, such consumer account information can include a mobile telephone number, an international mobile equipment identity (IMEI) number, or other unique communications device identifier. The retailer database 210 can further include data which is useful for negotiating a purchase price with a consumer. For example, such data can include a quantity of retail items existing in an inventory, a preferred purchase price for a retail item, and/or an acceptable counter-offer purchase price.

The retailer database 210 can include data associated with consumer profile information. For example, such consumer profile information can include a consumer's preferences. The retailer database 210 can also include consumer purchase information. For example, such consumer purchase information can include a retail item identifier for a retail item purchased by a consumer, a date a retail item was purchased by a consumer, and/or a price of a purchased retail item. The retailer database 210 can further include data associated with consumer buying trend information obtained through tracking a consumer's buying patterns. A person skilled in the art will appreciate that any data associated with the above listed types of information can be stored in the retailer database 210 according to any suitable population scheme, such as a table format.

A person skilled in the art will appreciate that the system 200 architecture is one embodiment of a system architecture in which the methods described below can be implemented. The invention is not limited in this regard and any system architecture can be used without limitation.

Referring now to FIG. 3, there is provided a simplified block diagram for the consumer communications device 202 that is useful for understanding the present invention. The consumer communications device 202 is comprised of a user interface 302, a central processing unit 306, a system bus 308, a memory 310 connected to and accessible by other portions of the consumer communications device 202 through system bus 308, and hardware entities 312 connected to system bus 308. The consumer communications device 202 is also comprised of a radio frequency (RF) antenna 314 and radio frequency (RF) hardware 304. The RF antenna 314 and the RF hardware 304 are well known to persons skilled in the art. Thus, the RF antenna 314 and the RF hardware 304 will not be described in detail herein. However, it should be understood that the RF antenna 314 and the RF hardware 304 enable communications between the consumer communications device 202 and an external device. Such an external device can include a retailer computer system 208 shown in FIG. 2.

At least some of the hardware entities 312 perform actions involving access to and use of the memory 310. The memory 310 may be a random access memory (RAM), a read only memory (ROM), a flash memory, a memory card, and/or a built-in hard disk. The hardware entitles 312 may include microprocessors, application specific integrated circuits (ASICs), and other hardware. The hardware entitles 312 may include a microprocessor programmed for accessing a retailer's site 208 (described above in relation to FIG. 2) and communicating with a retailer computer system 208 (described above in relation to FIG. 2).

The user interface 302 is comprised of input devices, output devices, and software routines configured to allow a user to interact with and control software applications installed on the consumer communications device 202. As such, the user interface 302 can facilitate a user-software interaction for creating a request to access the retailer's site 208 and for communicating with the retailer computer system 208. The user interface 302 can also facilitate a user-software interaction for accessing a notification and/or a negotiations software application installed on the consumer communications device 202. The software application can have a predefined menu system. Menu systems are well known to persons skilled in the art. Thus, menu systems will not be described in great detail herein.

However, it should be understood that the menu system and the user interface 302 can facilitate a user-software interaction for entering a retail item identifier, such as a unique sequence of numbers and/or a unique sequence of letters. The menu system and the user interface 302 can also facilitate a user-software interaction for obtaining a retail item identifier. For example, the menu system and the user interface 302 can facilitate a user-software interaction for capturing an image of a retail item identifier and/or capturing/reading a retail item identifier of a bar code. The menu system and the user interface 302 can further facilitate a user-software interaction for storing a retail item identifier in the memory 310. The user interface 302 may be comprised of a display screen, a speaker, and an input means, such as a keypad, a directional pad, a directional knob, a microphone, a camera, and/or a barcode reader/scanner.

The RF hardware 304 allows the consumer communications device 202 to communicate with the retailer site 208 through a wireless network 204 (described above in relation to FIG. 2). The RF hardware 304 is well known to persons skilled in the art. Thus, the RF hardware 304 will not be described in detail herein.

Those skilled in the art will appreciate that the consumer communications device 202 architecture illustrated in FIG. 3 is one possible example of a consumer communications device. However, the invention is not limited in this regard and any other suitable consumer communications device architecture can also be used without limitation.

Referring now to FIG. 4, there is provided a detailed block diagram of the retailer computer system 208 shown in FIG. 2. The retailer computer system 208 is comprised of a system interface 412, a user interface 402, a central processing unit 404, a system bus 406, a memory 408 connected to and accessible by other portions of the retailer computer system 208 through the system bus 406, and hardware entities 410 connected to the system bus 406. At least some of the hardware entities 410 perform actions involving access to and use of the memory 408, which may be a random access memory (RAM), a disk driver, and/or a compact disc read only memory (CD-ROM).

The hardware entities 410 may include microprocessors, application specific integrated circuits (ASICs), and other hardware. The hardware entities 410 may include a microprocessor programmed for accessing a retailer database 210 (described above in relation to FIG. 2), transmitting data to the retailer database 210, and retrieving data from the retailer database 210. The hardware entities 410 may also include a microprocessor programmed for retrieving consumer profile data, consumer preference data, and/or consumer shopping list data from a consumer communications device 202. The hardware entities 410 may further include a microprocessor programmed for generating a notification and communicating the same to a consumer communications device 202.

The user interface 402 is comprised of input devices, output devices, and software routines configured to allow a user to interact with and control software applications installed on the retailer computer system 208. As such, the user interface 402 can facilitate a user-software interaction for accessing the retailer database 210, transmitting data to the retailer database 210, and retrieving data from the retailer database 210. The user interface 402 can also facilitate a user-software interaction for accessing a purchase price notification/negotiation software application and for updating the purchase price notification/negotiation software application. The user interface 402 can further facilitate a user-software interaction for defining consumer account information, defining consumer profile information and defining historical purchase information associated with a consumer. The user interface 402 can facilitate a user-software interaction for storing consumer purchase information in the retailer database 210 and tracking a consumer buying trend.

The user interface 402 facilitates a user-software interaction for identifying a retail item having a negotiable purchase price, a special purchase price only available during certain hours of a business day, a special online store purchase price, and/or a special purchase price based on a total quantity of the retail item existing in an inventory. The user Interface 402 also facilitates a user-software interaction for identifying a retail item having a special purchase price based on a consumer profile, a consumer shopping list, and/or a consumer buying trend. The user interface 402 further facilitates a user-software interaction for assigning a product identifier to a particular retail item. The user interface 402 may be comprised of a display screen, a speaker, and an input means, such as a keypad, a directional pad, a directional knob, a microphone, a camera, and/or a bar code reader/writer.

The system Interface 412 allows the retailer computer system 208 to communicate with the consumer communications device 202 through a wireless network 204 (described above in relation to FIG. 2). The system interface 412 also allows the retailer computer system 208 to send and retrieve data from one or more retailer databases 210.

Those skilled in the art will appreciate that the retailer computer system 208 architecture illustrated in FIG. 4 is one possible example of a retailer computer system. However, the invention is not limited in this regard and any other suitable retailer computer system architecture can also be used without limitation.

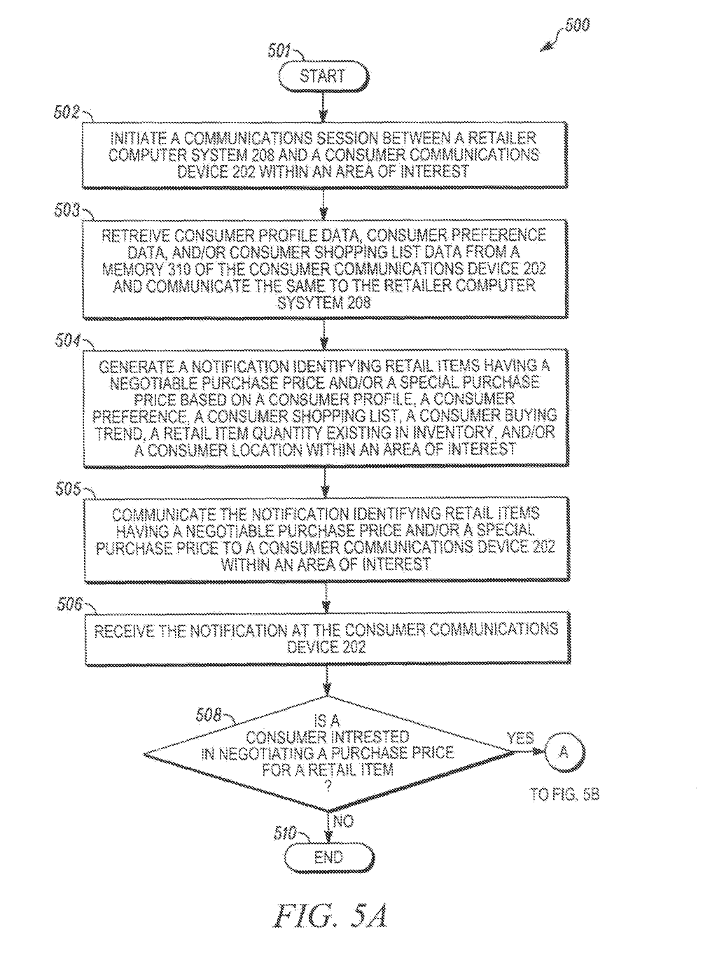

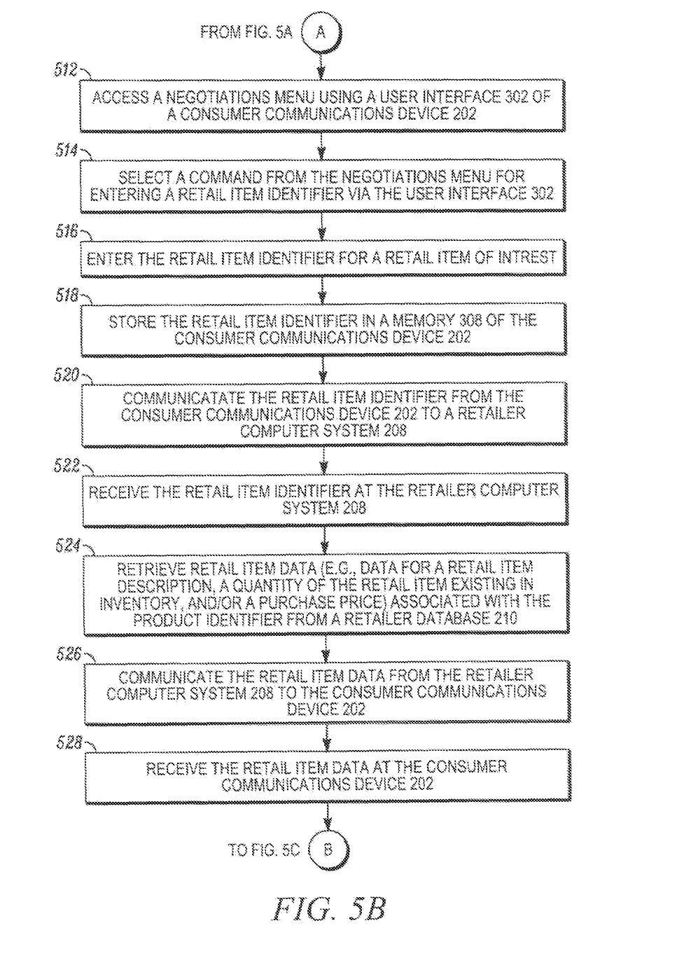

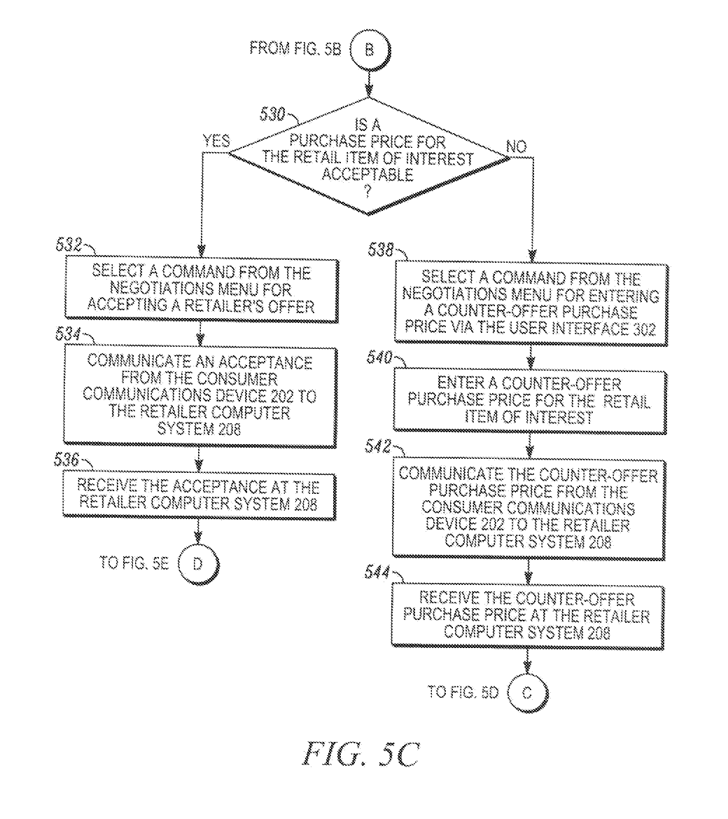

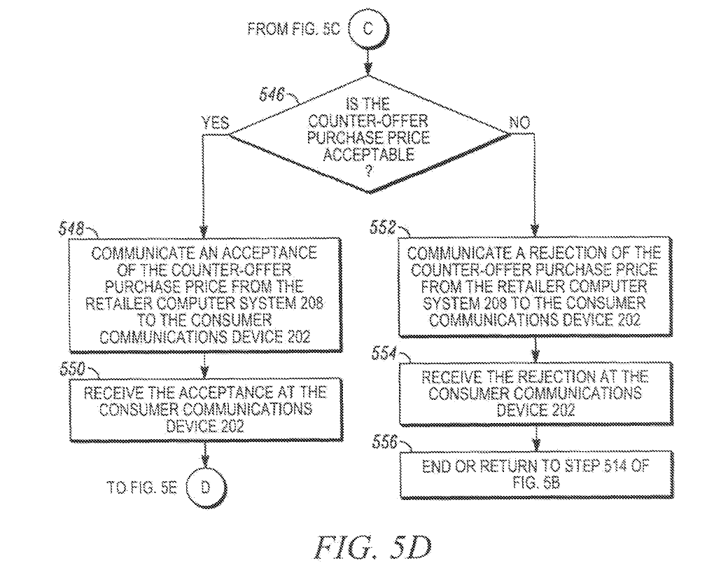

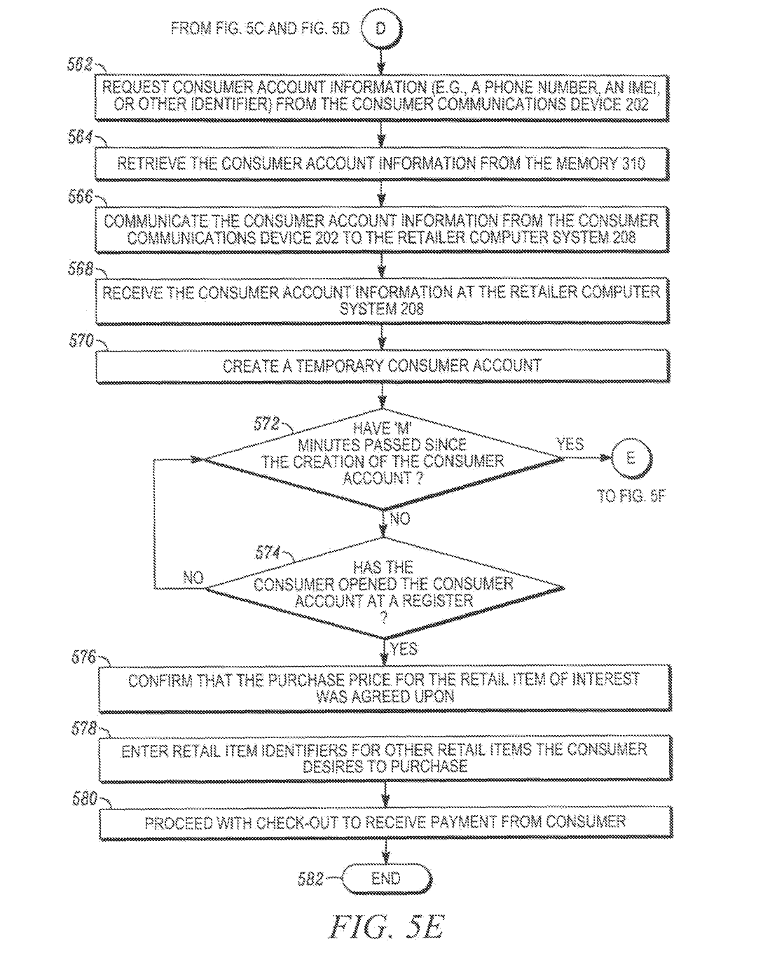

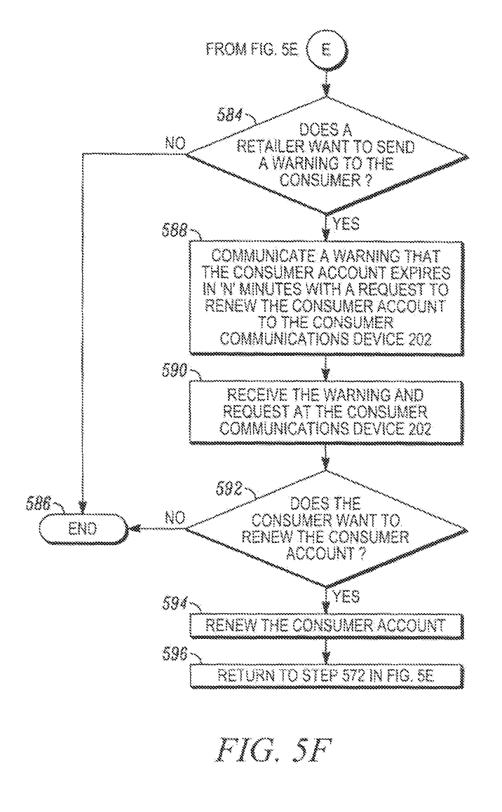

The following FIGS. 5A-5F and accompanying text illustrate a method 500 for a consumer notification and a retail item purchase price negotiation m accordance with the present invention. It should be appreciated, however, that the method disclosed herein is provided for purposes of illustration only and that the present invention is not limited solely to the method shown.

Referring now to FIG. 5A, the method 500 begins at step 501 and continues with step 502. In step 502, a communications session is initiated between a retailer computer system 208 (described above in relation to FIG. 2 and FIG. 4) and a consumer communications device 202 (described above in relation to FIG. 2 and FIG. 3). If should be understood that the consumer communications device 202 is present within an area of interest. The phrase “area of interest” as used herein refers to a particular physical location within a shopping establishment. For example, an area of interest can include an area at an entrance of the shopping establishment, an aisle of the shopping establishment, on an end cap of the shopping establishment aisles, and/or a checkout area where a consumer can pay for goods. Accordingly, the consumer communications device 202 is present within a shopping establishment. It should also be understood that any method known in the art for initiating a communications session between a retailer computer system 208 and a consumer communications device 202 can be used without limitation.

According to an embodiment of the invention, the communications session is initiated through use of a direct addressing scheme. For example, a shopping establishment has a scanning device located at an entrance. The consumer communications device 202 has a bar code label affixed to an exterior surface of the consumer communications device 202. The bar code label is comprised of a mobile telephone number. When a consumer enters a shopping establishment, the consumer registers with the retailer computer system 208 by scanning the bar code label. In turn, the scanning device captures the mobile telephone number. Subsequently, the scanning device performs actions to communicate the mobile telephone number to the retailer computer system 208. Upon receipt of a mobile telephone number, the retailer computer system 208 performs actions to call the mobile telephone number and initiate a communications session with the consumer communications device 202.

Alternatively, the bar code label is comprised of a subscriber identity number. When a consumer enters a shopping establishment, the consumer registers with the retailer computer system 208 by scanning the bar code label. In turn, the scanning device captures the subscriber identity number. Subsequently, the scanning device performs actions to communicate the subscriber identity number to the retailer computer system 208. Upon receipt of a subscriber identity number, the retailer computer system 208 performs actions to access the retailer database 210 and retrieve subscriber information associated with the subscriber identity number from the retailer database 210. The subscriber information Includes a mobile telephone number for the consumer communications device 202. After retrieving the mobile telephone number, the retailer computer system 208 performs actions to call the mobile telephone number and initiate a communications session with the consumer communications device 202.

According to another embodiment of the invention, the communications session is initiated through use of a manual registration scheme. For example, a consumer accesses a menu of the predefined menu system using a user interface 302 (described above in relation to FIG. 3) of the consumer communications device 202. The consumer selects a command from the menu for entering a text message via the user interface 302. Thereafter, the consumer enters the text message into the consumer communications device 202 via a keypad. The text message can identify a mobile telephone number and/or an indication that the consumer is within the area of interest. Subsequently, the consumer communications device 202 performs actions to temporarily store the text message in a memory 310 (described above in relation to FIG. 3). After storing the text message, the consumer communications device 202 performs actions to communicate the text message to the retailer computer system 208. Upon receipt of the text message, the retailer computer system 208 performs actions to call the mobile telephone number and initiate a communications session with the consumer communications device 202.

Alternatively, the consumer accesses a menu of the predefined menu system using a user interface 302 (described above in relation to FIG. 3) of the consumer communications device 202. The consumer selects a command from the menu for initiating a communications session with the retailer computer system 208. In effect, the consumer communications device 202 automatically performs actions to establish a wireless WAN, wireless LAN, or wireless PAN link with the retailer computer system 208 and initiate a communications session.

According to yet another embodiment of the invention, the communications session is initiated through use of a broadcast message, alert, or computerized call to registered consumers. In this scenario, the consumers register with the retailer computer system 208 at a cashier assisted register or a self checkout register. This registration process includes entering a mobile telephone number of the consumer communications device 202 into a computer system of the cashier assisted register or a self checkout register. Once a mobile telephone number is entered into the computer system, the computer system performs actions to communicate the same to the retailer computer system 208. Upon receipt of the mobile telephone number, the retailer computer system 208 performs actions to store the same In the retailer database 208. Thereafter, the retailer computer system 208 generates a broadcast message and communicates the same to all or a portion of the mobile telephone numbers stored in the retailer database 208.

Referring again to FIG. 5A, the method 500 continues with step 503 where the consumer communications device 202 performs actions to retrieve consumer profile data, consumer preference data, and/or consumer shopping list data from a memory 310 of the consumer communications device 202. Thereafter, the consumer communications device 202 performs actions to communicate the retrieved consumer profile data, consumer preference data, and/or consumer shopping list data to the retailer computer system 208.

In step 504, the retailer computer system 208 performs actions to generate a notification identifying retail items having special purchase prices and/or negotiable purchase prices. According to an embodiment of the invention, the notification identifies a retail item having a special purchase price based on consumer information. In this regard, it should be appreciated that the non-advertised retail item can be a retail item identified in consumer profile data. The non-advertised retail item can also be a retail item identified in consumer shopping list data.

According to another embodiment of the invention, the notification identifies a retail item having a special purchase price only available during certain times of a business day. For example, the notification identifies a retail item having a special purchase price only available during off-peak hours of a business day. The notification can also identify a retail item having a special online store purchase price. As should be appreciated, such a notification can encourage a consumer to shop in a shopping establishment during off-peak hours. Such a notification can also encourage a consumer to shop through an online shopping system. As such, common issues experienced by a shopping establishment having limited human resources and limited parking resources may be somewhat alleviated.

According to another embodiment of the invention, the notification identifies a retail item having a special purchase price based on one or more previous consumer purchases from a shopping establishment. In this regard it should be understood that such a notification may be based on historical data stored in the retailer database 210. Such a notification can also be based on a consumer's buying trend identified from the stored historical data. For example, the retailer computer system 208 is notified that the consumer communications device 202 is present within a shopping establishment. In response, the retailer computer system 208 performs actions to generate a notification and communicate the same to the consumer communications device 202. In this regard, it should be understood that historical data associated with a consumer's buying trend is stored in the retailer database 210. This historical data indicates that the consumer buys flour every week from the shopping establishment. Accordingly, the notification identifies a brand of flour having a special discount purchase price. As should be appreciated, such a notification can persuade a consumer to shop frequently at the shopping establishment. Such a notification can also inform the consumer that he/she is overdue for purchasing flour.

According to yet another embodiment of the invention, the notification identifies a retail item having a special purchase price based on a total quantify of the retail item existing in a shopping establishment inventory. For example, a shipment of a retail item is received at a shopping establishment. Accordingly, a notification is communicated to the consumer communications device 202 that identifies the retail item as having a special discount purchase price based on the quantity of the retail item received in the shipment and the quantity of the retail item existing in stock. As should be appreciated, such a notification can allow for a seamless purchase price reduction based on available retail items at a shopping establishment.

Referring again to FIG. 5A, the method 500 continues with step 505. In step 505, the notification is communicated to a consumer communications device 202 via a wireless network 204 (described above in relation to FIG. 2). It should be understood that the consumer communications device 202 is present within an area of interest. For example, the consumer communications device 202 is present within a particular area of a shopping establishment. As explained above, the precise nature of the notification is not critical. Instead, such notification is primarily intended to initiate a user interaction with a retailer site 206 (described above in relation to FIG. 2).

In step 506, the notification is received at the consumer communications device 202. Thereafter, the method 500 continues with a decision step 508. If a consumer is not interested in negotiating a purchase price for a retail item having a negotiable purchase price (508:NO), then step 510 is performed where the method 500 ends. If the consumer is interested in negotiating a purchase price for a retail item (508:YES), then the method 500 continues with step 512 of FIG. 5B.

In step 512, a purchase price negotiations software application installed on the consumer communications device 202 is accessed by the consumer. As described above in relation to FIG. 3, the purchase price negotiations software application has a predefined menu system. Accordingly, the consumer accesses a negotiations menu of the predefined menu system using a user interface 302 (described above in relation to FIG. 3) of the consumer communications device 202. Thereafter, step 514 is performed where the consumer selects a command from the negotiations menu for entering a retail item identifier via the user interface 302. In step 516, a retail item identifier for a retail item of interest is entered into the consumer communications device 202 via a keyboard, a microphone, a camera, or a bar code reader/scanner. Subsequently, step 518 is performed where the consumer communications device 202 performs actions to store the entered retail item identifier in a memory 310 (described above in relation to FIG. 3). After step 518, step 520 is performed where the consumer communications device 202 performs actions to communicate the retail item identifier to the retailer computer system 208.

In step 522, the retail item identifier is received at the retailer computer system 208. Upon receipt of a retail item identifier, the retailer computer system 208 performs actions to access a purchase price notification/negotiation software application installed on the retailer computer system 208. After accessing the purchase price notification/negotiation software application, the retailer computer system 208 performs actions to access the retailer database 210. The retailer computer system 208 also performs actions to retrieve retail item data associated with the received retail item identifier from the retailer database 210. It should be understood that the retail item data includes data associated with a description of a retail item, a quantify of the retail item existing in an inventory, and/or a preferred purchase price for the retail item. In step 526, the retailer computer system 208 performs actions to communicate the retrieved retail item data to the consumer communications device 202. In step 528, the retail item data is received at the consumer communications device 202. Thereafter, the method 500 continues with a decision step 530 of FIG. 5C.

If the purchase price contained within the retail item data is unacceptable (530;NO), then the method 500 continues to a step 538. In step 538, the predefined menu system of the purchase price negotiations software application is accessed by the consumer via the user interface 302. In this regard, it should be understood that the consumer accesses the negotiations menu of the predefined menu system and selects a command from the negotiations menu for entering a counter-offer purchase price. Thereafter, the counter-offer purchase price is entered into the consumer communications device 202 via a keyboard or a microphone. Subsequently, step 542 is performed where the consumer communications device 202 performs action to communicate the counter-offer purchase price to the retailer computer system 208. After step 542, step 544 is performed where the method 500 continues with a decision step 546 of FIG. 5D.

If the counter-offer purchase price Is unacceptable (546:NO), then step 552 is performed where the retailer computer system 208 performs actions to communicate a rejection of the counter-offer purchase price to the consumer communications device 202 via the wireless network. In this regard, it should be appreciated that such a determination is automatically determined by the retailer computer system 208 based on some purchase price negotiation criteria. Such purchase price negotiation criteria can include, but is not limited to, a predefined price range and/or a quantity of the retail item existing in an inventory. In step 554, the rejection is received at the consumer communications device 202. Thereafter, step 556 is performed where the method 500 ends or returns to step 514 of FIG. 5B.

If the counter-offer purchase price is acceptable (546:YES), then step 548 is performed where the retailer computer system 208 performs actions to communicate an acceptance of the counter-offer purchase price to the consumer communications device 202 via the wireless network. In this regard, it should be appreciated that such a determination is automatically determined by the retailer computer system 208 based on some purchase price negotiation criteria. Such purchase price negotiation criteria can include, but is not limited to, a predefined price range and/or a quantity of the retail item existing in an inventory. In step 550, the acceptance is received at the consumer communications device 202. Thereafter, the method 500 continues with step 562 of FIG. 5E (described in detail below).

If the purchase price contained within the retail item data is acceptable to the consumer (530:YES), then the method 500 continues to a step 532. In step 532, the predefined menu system of the purchase price negotiations software application is accessed by the consumer via the user interface 302. In this regard, it should be understood that the consumer accesses the negotiations menu of the predefined menu system and selects a command from the negotiations menu for accepting a retailer's offer. In response, the consumer communications device 202 performs actions to communicate an acceptance to the retailer computer system 208 via the wireless network. Subsequently, step 534 is performed where the acceptance is received at the retailer computer system 208. Thereafter, the method 500 continues with a step 562 of FIG. 5E.

In step 562, the retailer computer system 208 performs actions to communicate a request for consumer account information to the consumer communications device 202. In this regard, it should he appreciated that the consumer account information can include a mobile telephone number, an international mobile equipment identity (IMEI) number, and/or other unique communication equipment identifier. In step 564, the consumer communications device 202 performs actions to retrieve consumer account information from a memory 310 of the consumer communications device 202. Thereafter, consumer communications device 202 performs actions to communicate the consumer account information to the retailer computer system 208. In step 568, the consumer account information is received at the retailer computer system 208.

After step 568, the method 500 continues with step 570 where the retailer computer system 208 performs actions to create a temporary consumer account in the retailer database 210. This step can involve storing the consumer account information in the retailer database 210 along with a retail item identifier and an agreed upon purchase price. Thereafter, the method 500 continues with a decision step 572. If “M” minutes have not passed since the creation of the consumer account (572:NO), then the method 500 continues with a decision step 574. In step 574, a determination is made as to whether the consumer has ‘opened’ the consumer account at a register. It should be appreciated that the register can be a cashier assisted register or a self checkout register.

In this regard, it should be appreciated that the term ‘open’ as used herein refers to a process for displaying contents of a consumer account on a display screen of the register and starting a check-out application installed in a computer processing system of the register. Check-out applications are well known to persons skilled in the art. Thus, such applications will not be described in great detail herein. However, it should be appreciated that any such check-out application can be used without limitation, provided that it is in accordance with a particular system 200 application.

It should also be appreciated that the consumer can ‘open’ the consumer account by scanning a bar code label attached to an exterior surface of the consumer communications device 202 at the register. The bar code label is comprised of a mobile telephone number, an international mobile equipment identity (IMEI) number, and/or other unique communication equipment identifier.

If the consumer has not ‘opened’ the consumer account at the register (574:NO), the method 500 returns to the decision step 572. However, if the consumer has ‘opened’ the consumer account at the register (574:YES), then step 576 is performed where the agreed upon purchase price for a retail item of interest is confirmed. This confirmation can be achieved through any means known in the art. For example, if the register is a cashier assisted register, then a confirmation request can be outputted to the cashier via a display screen of the cashier assisted register. In response, the cashier can ask the consumer whether this is the correct agreed upon purchase price for the retail item of interest. In turn, the cashier can enter a ‘yes’ or a ‘no’ into the cashier assisted register via a user interface. However, if the register is a self checkout register, then a confirmation request can be outputted to the consumer via a display screen of a self checkout register. In response, the consumer can enter a ‘yes’ or a ‘no’ info the cashier assisted register via a user interface. After step 576, step 578 is performed where retail item identifiers for other retail items the consumer desires to purchase are entered into a computer processing device of the register. In step 580, payment is received from the consumer. Thereafter, step 582 is performed where the method 500 ends.

If “M” minutes have passed since the creation of the consumer account (572:YES), then the method 500 continues with a decision step 584 of FIG. 4F. If the retailer does not want to send a warning to the consumer (584:NO), then step 586 is performed where the method 500 ends. However, if the retailer wants to send a warning to the consumer (584:YES), then the method 500 continues with a step 588. In step 588, the retailer computer system 208 performs actions to communicate a warning to the consumer communications device 202. In this regard, it should be understood that the warning can indicate that the consumer account will expire in ‘M’ minutes and may be renewed by the consumer.

In step 590, the warning is received at the consumer communications device 202. After step 590, a decision step 592 is performed where a determination is made as to whether the consumer wants to renew the consumer account. If the consumer wants to renew the consumer account (592:YES), then step 594 is performed. In step 594, the predefined menu system of the purchase price negotiations software application is accessed by the consumer via the user interface 302. In this regard, if should be understood that the consumer accesses the negotiations menu of the predefined menu system and selects a command from the negotiations menu for renewing the consumer account. In response, the consumer communications device 202 performs actions to communicate a command to renew the consumer account to the retailer computer system 208 via the wireless network. Subsequently, the command is received at the retailer computer system 208. Thereafter, the retailer computer system 208 performs actions to renew the consumer account. After step 594, step 596 is performed where the method 500 returns to step 572 of FIG. 5E. If the consumer does not want to renew the consumer account (592:NO), then step 586 is performed where the method 800 ends.

A person skilled in the art will appreciate that the method 500 is one embodiment of a method for a consumer notification and a retail item purchase price negotiation. The invention is not limited in this regard and any other method for a consumer notification and a retail item purchase price negotiation can foe used without limitation.

It should be appreciated that the present invention may be embodied in many different forms and should not be construed as limited to the embodiments set forth herein. For example, the present invention can be embodied as a method, a data processing system, or a computer program product. Accordingly, the present invention can take the form as an entirely software embodiment or a hardware/software embodiment.

The present invention can he realized in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention can take the form of a computer program product on a computer-usable storage medium having computer-usable program code embodied in a medium, such as a hard disk or a CD-ROM. The term computer program product, as used herein, refers to a device comprised of all the features enabling the implementation of the methods described herein, and which, when loaded in a computer system, is able to carry out these methods. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

In this regard, it should be appreciated that above described method 400 for a consumer notification and a retail item purchase price negotiation can be implemented in computer program code. In such a scenario, the computer program code for carrying out the routines and functions of the present invention can be written in an object orientated programming language such as Java®, Smalltalk, C++, or Visual Basic®. However, the computer program code for carrying out the routines and functions of the present invention can also be written in conventional procedural programming languages, such as “C” programming language.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for interacting with a consumer in a shopping establishment, comprising:
generating a notification identifying at least one of a retail item having a special purchase price and a retail item having a negotiable purchase price; and
communicating said notification to a wireless communications device located within an area of a shopping establishment and belonging to a consumer.

2. The method according to claim 1, further comprising selecting said special purchase price to be a special purchase price based on a total quantity of said at least one retail item existing in an inventory.

3. The method according to claim 1, further comprising selecting said special purchase price to be a special purchase price based on a consumer profile.

4. The method according to claim 1, further comprising selecting said special purchase price to be a special purchase price based on a consumer shopping list.

5. The method according to claim 4, further comprising selecting said consumer shopping list to be a shopping list stored in a memory of said wireless communications device.

6. The method according to claim 1, further comprising selecting said special purchase price to be a special purchase price based on a prior purchase of said at least one retail item by a consumer.

7. The method according to claim 1, further comprising selecting said special purchase price to be a special purchase price based on a consumer buying trend.

8. The method according to claim 1, further comprising selecting said special purchase price to be a special purchase price only available during a selected time of a business day or a special online store purchase price.

9. The method according to claim 8, further comprising selecting said time to be off-peak hours of said business day.

10. The method according to claim 1, further comprising selecting said special purchase price to be a special purchase price available only to consumers in a shopping establishment when said notification is sent.

11. The method according to claim 1, further comprising determining whether a consumer is interested in negotiating a purchase price for said retail item having a negotiable purchase price.

12. The method according to claim 11, further comprising communicating with said wireless communications device to negotiate said purchase price for said retail item having a negotiable purchase price if it is determined that said consumer is interested in negotiating said purchase price for retail item having a negotiable purchase price.

13. The method according to claim 1, further comprising communicating said notification to said wireless communications device via a wireless network.

14. The method according to claim 13, further comprising selecting said wireless network to be a local area network, a wide area network, or a personal area network.

15. The method according to claim 1, further comprising selecting said area of said shopping establishment to be an entrance of said shopping establishment, an aisle of said shopping establishment, or an aisle end cap of said shopping establishment.

16. A system for interacting with a consumer in a shopping establishment, comprising:
a retailer computer system configured for communicating a notification to a wireless communications device located in a shopping establishment and belonging to a consumer, said notification identifying at least one of a retail item having a special purchase price and a retail item having a negotiable purchase price; and
wherein said retailer computer system is further configured for automatically communicating with said wireless communications device and automatically negotiating a purchase price for said retail item having a negotiable purchase price if it is determined that said consumer is interested in negotiating a purchase price for said retail item having a negotiable purchase price.

17. The system according to claim 18, wherein said retailer computer system is further configured for selecting said special purchase price to be a special purchase price based on at least one criteria selected from the group consisting of a consumer profile, a consumer shopping list, a prior purchase of said consumer, or a consumer buying trend.

18. The system according to claim 18, wherein said retailer computer system is further configured for selecting said special purchase price to be a special purchase price based on a total quantity of said at least one retail item existing in an inventory.

19. The system according to claim 16, wherein said retailer computer system is further configured for selecting said notification to further include identifying at least one non-advertised retail item only available at a given shopping establishment and having a negotiable purchase price.

20. The method according to claim 16, wherein said wireless communications device is responsive to an input from said consumer for communicating information concerning said negotiable purchase price.
